(19) United States
(12) Patent Application Publication
(10) Pub. No.: US 2018/0202914 A1
(43) Pub. Date: Jul. 19, 2018

(54) SENSOR AND METHOD FOR PRODUCING A SENSOR

(71) Applicant: Continental Automotive GmbH, Hannover (DE)

(72) Inventors: Erich MATTMANN, Heidesheim (DE); Michael NITZSCHKE, Hattersheim (DE); Christian WEIGERT, Mallersdorf-Pfaffenberg (DE); Gary COLLIER, I, Regensburg (DE); Andreas GERULL, Tegernheim (DE); Christian KIEFL, Regensburg (DE); Kay SCHWARZKOPF, Regensburg (DE)

(73) Assignee: Continental Automotive GmbH, Hannover (DE)

(21) Appl. No.: 15/923,428

(22) Filed: Mar. 16, 2018

Related U.S. Application Data
(63) Continuation of application No. PCT/EP2016/071136, filed on Sep. 8, 2016.

(30) Foreign Application Priority Data
Sep. 17, 2015 (DE) 10 2015 217 794.7

(51) Int. Cl. G01N 15/06

(52) U.S. Cl. CPC G01N 15/0606; G01N 2015/0046; G01N 15/0656

(57) ABSTRACT

A sensor, such as an electrostatic particle sensor, having a housing in which a sensor element is disposed, and a gas-tight electrical feedthrough through the housing, the feedthrough being configured for directing electrical currents and/or voltages from electrical components that are disposed outside the housing into the housing and/or out of the housing. In order for a sensor which permanently has at least one gas-tight electrical feedthrough through the housing thereof to be provided, the electrical feedthrough has a ceramic molded body which has at least one through bore, the latter having a first end and a second end, wherein the through bore from the first end up to the second end is filled with a metallic paste, and the ceramic molded body in a sintering process is connected to the metallic paste, and in the region of the first end and/or of the second end of the through bore at least one metallic tube piece is attached to the sintered metallic paste.

### CROSS-REFERENCE TO RELATED APPLICATIONS

This application claims the benefit of PCT Application PCT/EP2016/071136, filed Sep. 8, 2016, which claims priority to German Patent Application 10 2015 217 794.7, filed Sep. 17, 2015. The disclosures of the above applications are incorporated herein by reference.

### FIELD OF THE INVENTION

The invention relates to a sensor having a housing in which a sensor element is disposed, and to a method for producing the sensor.

### BACKGROUND OF THE INVENTION

Ever more stringent regulatory requirements relating to permissible pollutant emissions in the case of motor vehicles having internal combustion engines render it necessary that the pollutant emissions in the operation of the internal combustion engine are kept as low as possible. On account thereof, it is necessary for the exhaust gas parameters in the exhaust tract to be determined in a very precise manner, in particular for the use of exhaust gas post-treatment systems such as catalytic converters.

Nitrous oxide sensors, high-temperature sensors, oxygen sensors and/or carbon-particulate matter sensors, for example, may be used for determining these exhaust gas parameters.

A nitrous oxide sensor is known from the technical book “Handbuch Verbrennungsmotoren” (“Manual of internal combustion engines”), published by Richard von Basshuysen/Fred Schäfer, 2nd edition, June 2002, Friedrich Vieweg & Sohn Verlagsgesellschaft mbH Braunschweig/Wiesbaden, pages 589 and following, the nitrous oxide sensor being based on ZrO₂ ceramics and having two chambers. A constant partial pressure of the oxygen contained in the exhaust gas is established in the first chamber by applying a pumping current. The pumping current is in inverse proportion to the air-to-fuel ratio. The nitrous oxide contained in the exhaust gas is decomposed in the second chamber by applying a further current. Thereupon, a current which is proportional to the nitrous oxide content in the exhaust gas and which forms the measuring signal of the nitrous oxide sensor may be measured on a measuring electrode in the second chamber.

The German first and unexamined patent publication DE 199 59 871 A1 discloses a method for measuring carbon-particulate matter and a device therefor. It is proposed that an electrical field is generated by applying a constant electrical DC voltage between a jacket electrode that is perfused by the gas flow and an internal electrode within the jacket electrode, and that the charging current for maintaining the constant DC voltage between the jacket electrode and the internal electrode is measured.

All sensors that are used in the exhaust track are exposed to very high temperatures (up to approximately 1000° C.) and to very high temperature variations. In the case of an internal combustion engine that has cooled down, the temperatures at the sensor may drop to below −30° C., and may rise to more than 1000° C. in the case of a hot internal combustion engine, so that temperature differentials of more than 1030° C. have to be endured without damage by the sensor, specifically over a multiplicity of temperature cycles. Enormous requirements are set herein for the electrical feedthroughs of the sensor, in particular when the feedthroughs are to be configured in a gas-tight manner. Moreover, some sensors in the exhaust track are operated at very high voltages of approximately 1000 V, this setting additional requirements for the feedthroughs used.

### SUMMARY OF THE INVENTION

The object of the invention is to provide a sensor which permanently has at least one gas-tight electrical feedthrough through the housing thereof.

The object is achieved by the features of the independent patent claims. Advantageous design embodiments of the invention are characterized in the dependent claims.

On account of the electrical feedthrough having a ceramic molded body which has at least one through bore, the latter having a first end and a second end, wherein the through bore from the first end up to the second end is filled with a metallic paste, and the ceramic molded body in a sintering process is connected to the metallic paste, and in the region of the first end and/or of the second end of the through bore at least one metallic tube piece is attached to the sintered metallic paste, a permanently gas-tight feedthrough which does not lose the tightness thereof even in the case of pronounced temperature changes is established. The sintering process leads to a connection between the metallic paste and the ceramic molded body which is extremely strong and is particularly durable.

According to one advantageous design embodiment, the sensor is configured for measuring in gases having a temperature above 400° C. These temperatures regularly arise in the exhaust tract of motor vehicles, particular requirements thus being set for the gas-tight electrical feedthroughs. Moreover, very large temperature variations which may only be compensated for by a particularly high-grade electrical feedthrough are caused on account of the cyclical heating and cooling of the exhaust system.

According to one further design embodiment, the metallic paste is a tungsten and/or platinum paste. Tungsten and/or platinum pastes have a very positive electrical conductivity and in the sintering process connect excellently to the ceramic molded body.

According to a further advantageous design embodiment, the sensor is configured as an electrostatic particle sensor. Electrostatic particle sensors are often operated at very high voltages, this representing an additional challenge to the electrical feedthrough. The electrical feedthroughs in the case of electrostatic particle sensors therefore have to be high-voltage resistant and gas-tight and have these properties even at temperatures of approximately 1000° C., and permanently survive frequent temperature changes of more than 1000° C. without damage. A high-grade electrical feedthrough of this type is provided by the sensor according to the invention.

In the case of one refinement, the metallic tube piece is configured as a guard tube for forming an electrical field in the housing of the sensor. In the case of electrostatic particle sensors, guard tubes of this type are used for compensating leakage currents, for example in order for the measurement of carbon-particle matter in the exhaust flow to be designed in a more precise manner. To this end, the metallic tube piece may be advantageously attached to the sintered metallic paste by soldering/brazing or welding.

If performed at least at 1500° C., the connection between the metallic paste and the ceramic molded body is configured in a particularly high-grade manner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Exemplary embodiments of the invention will be explained in more detail hereunder by means of the schematic drawings. In the figures:

FIG. 1 shows a sensor according to the prior art;

FIG. 2 shows a sensor according to the invention.

### DETAILED DESCRIPTION OF THE PREFERRED EMBODIMENT

The following description of the preferred embodiment(s) is merely exemplary in nature and is in no way intended to limit the invention, its application, or uses.

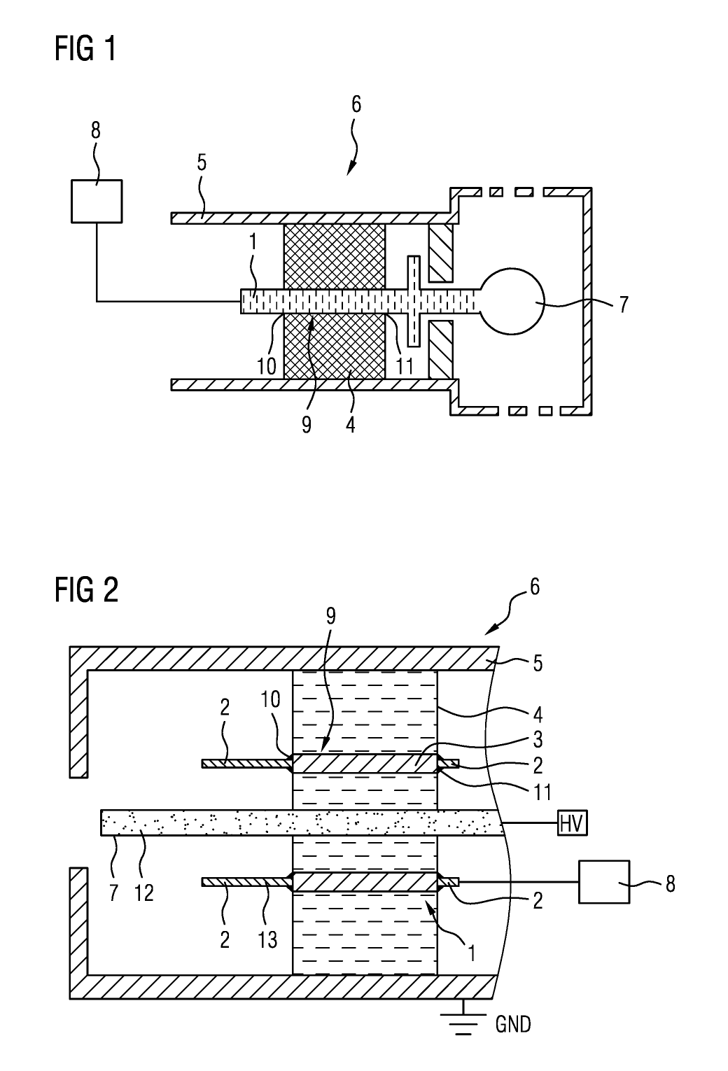

FIG. 1 shows a sensor 6 according to the prior art. The sensor 6 has a housing 5 in which a sensor element 7 is disposed. The sensor element 7 may be, for example, an electronic sensor element which measures a temperature, a pressure, or gas components. However, the sensor element 7 may also be a simple electrode which with the aid of a high voltage generates an electrical field which is configured, for example, between the sensor elements 7 and the housing 5. Moreover, the sensor 6 according to the prior art has a ceramic molded body 4 in which a through bore 9 which is used as an electrical feedthrough 1 is configured. The through bore 9 through the ceramic molded body 4 has a first end 10 and a second end 11. An electrical component 8 which is located outside the housing 5 of the sensor 6 may be connected to the electrical feedthrough 1. The sensor element 7 is thus electrically connected to the electrical component 8, by way of which signals from the sensor element 7 are transmitted through the electrical feedthrough 1 to the electrical component 8, for example. However, it is also conceivable that a high voltage is applied by way of the electrical component 8 through the electrical feedthrough 1 to the sensor element 7, for example.

FIG. 2 shows a sensor 6 according to the invention, having a housing 5 in which the sensor element 7 is disposed. The sensor element 7 in this exemplary embodiment is configured as a simple electrode 12. An electrical field may be configured between the electrode 12 and the housing 5 of the sensor 6 in that a high voltage HV is applied to the electrode 12, and the housing 5 of the sensor 6 is connected to the ground GND. Guard tubes 13 which are used in a targeted manner for forming the electrical field that is configured in the sensor housing are furthermore to be seen in the housing 5 of the sensor 6. Moreover, a compensation of leakage currents is possible by way of the guard tubes 13. The housing 5 of the sensor has a gas-tight electrical feedthrough 1. Currents and voltages from electrical components 8 that are disposed outside the housing 5 are directed into the housing or out of the housing 5 by way of this feedthrough 1. The electrical feedthrough 1 is configured as a ceramic molded body 4 which has at least one through bore 9. The through bore 9 has a first end 10 and a second end 11. It is seen that the through bore 9 from the first end 10 up to the second end 11 is filled with a metallic paste 3. This metallic paste may be a tungsten paste or a platinum paste, for example. The ceramic molded body 4 was connected to the metallic paste 3 in a sintering process. The temperature in the sintering process may be 1500° C., for example. Metallic tube pieces which may be configured as guard tubes, for example, are attached to the sintered metallic paste 3 in the first region of the molded body 4 and in the second region of the molded body 4. These metallic tube pieces 2 may be attached to the sintered metallic paste by soldering/brazing or welding, for example. The sensor according to the invention may be used, for example, for measuring carbon-particle matter in the exhaust tract of a motor vehicle. Very high temperatures of up to 1000° C. at which the sensor 6 according to the invention has to permanently have gas-tight electrical feedthroughs 1 typically prevail in the exhaust tract of a motor vehicle. Both the tube pieces 2 which are configured as guard tubes 13 and the electrode 12 that forms the sensor element 7 may be configured as a feedthrough according to the invention. The sensor 6 according to the invention has permanently gas-tight electrical feedthroughs because the metallic paste 3 in the context of the sintering process forms a permanently tight connection with the molded body 4.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A sensor comprising:
a housing;
a sensor element disposed in the housing;
a gas-tight electrical feedthrough extending through the housing;
a plurality of electrical components disposed outside the housing, the gas-tight electrical feedthrough being configured for directing electrical currents or voltages from the electrical components into the housing or out of the housing;
the gas-tight electrical feedthrough further comprising:
a ceramic molded body;
at least one through bore having a first end and a second end, the at least one through bore being part of the ceramic molded body;
a metallic paste, the through bore is filled with the metallic paste from the first end up to the second end, and the ceramic molded body is connected to the metallic paste using a sintering process;
at least one metallic tube piece attached to the sintered metallic paste in the region of at least of the first end or of the second end of the through bore.

2. The sensor of claim 1, wherein the sensor is configured for measuring in gases having a temperature above 400° C.

3. The sensor of claim 1, the metallic paste further comprising at least one of a tungsten paste or a platinum paste.

4. The sensor of claim 1, the sensor further comprising an electrostatic particle sensor.

5. The sensor of claim 4, the metallic tube piece further comprising a guard tube for forming an electrical field in the housing of the sensor.

6. The sensor of claim 1, wherein the metallic tube piece is attached to the sintered metallic paste by at least one of soldering, brazing, or welding.

7. The sensor of claim 1, wherein the sintering process is performed at least at 1500° C.

8. A method for producing a sensor, comprising the steps of:
providing a housing;
providing a sensor element disposed in the housing;
providing a gas-tight electrical feedthrough extending through the housing, the gas-tight electrical feedthrough comprising:
providing a ceramic molded body;
providing at least one through bore having a first end and a second end, the at least one through bore being part of the ceramic molded body;
providing a metallic paste; and
providing at least one metallic tube piece;
configuring the gas-tight electrical feedthrough being directing electrical currents or voltages from the electrical components into the housing or out of the housing;
filling the through bore with the metallic paste from the first end up to the second end;
sintering the metallic paste at a minimum temperature of at least 1500° C. to connect the ceramic molded body to the metallic paste;
attaching the at least one metallic tube piece to the sintered metallic paste in the region of at least of the first end or of the second end of the through bore.
